(19) United States
(12) Patent Application Publication
(10) Pub. No.: US 2026/0194795 A1
(43) Pub. Date: Jul. 9, 2026

(54) NOVEL CAMERA STRAP

(71) Applicant: Hua Li, Shenzhen (CN)

(72) Inventor: Hua Li, Shenzhen (CN)

(21) Appl. No.: 19/012,808

(22) Filed: Jan. 7, 2025

(51) Int. Cl. G03B 17/56

(52) U.S. Cl. CPC G03B 17/561

(57) ABSTRACT

Disclosed belongs to the technical field of camera strap, particularly related to a novel camera strap, which solves the problem of inadequate comfort in the prior art, wherein comprising a camera strap and two external straps, the two external straps are affixed to the two ends of the camera strap. The camera strap comprises two external leathery friction layers and two buffer layers. The two external leathery friction layers are provided on the outer peripheral surfaces of the camera strap. The two buffer layers are provided on the inner walls of the two external leathery friction layers. An internal leathery friction layer is provided between the external leathery friction layer and the buffer layer. A buffer hollow friction layer is provided between the two buffer layers. The external leathery friction layer has a soft touch, and the buffer layer serves to effectively alleviate the back pressure and enhance user experience.

### TECHNICAL FIELD

The present disclosure relates to the technical field of camera strap, and more particularly to novel camera straps.

### BACKGROUND

Presently, camera straps are a carrying accessories designed specifically for cameras.

The existing camera straps, while serving to accommodate the needs of photography enthusiasts with regard to carrying cameras to a certain extent, nevertheless exhibit a number of deficiencies. The design of traditional camera straps frequently fails to consider the comfort of users who are required to carry them over an extended period of time. The use of a single material and a lack of sufficient buffering results in users experiencing discomfort and tenderness in their shoulders when shooting or walking for an extended duration. Furthermore, the existing straps are constructed with a relatively simple structure, lacking multi-level protection and support. This renders the camera susceptible to external impacts and damage during the carrying process. Above all, traditional camera straps are deficient in terms of durability, which is often compromised by material and process limitations, particularly in cases where they are subjected to frequent use or operate in harsh environments that accelerate wear and tear. This results in a significant reduction in their operational lifespan. Furthermore, the absence of an effective hierarchical structure and reinforcement design renders the straps susceptible to breakage or deformation following prolonged use, thereby causing inconvenience and losses to users.

### SUMMARY

The purpose of this present invention is to provide a novel camera strap, which addresses the issue of inadequate comfort.

In order to achieve the above purpose, the present invention provides the following technical solution: a novel camera strap comprising a camera strap and two external straps, the two external straps are affixed to the two ends of the camera strap. The camera strap comprises two external leathery friction layers and two buffer layers. The two external leathery friction layers are provided on the outer peripheral surfaces of the camera strap, the two buffer layers are provided on the inner walls of the two external leathery friction layers.

Optionally, an internal leathery friction layer is provided between the external leathery friction layer and the buffer layer.

Optionally, a buffer hollow friction layer is provided between the two buffer layers.

Optionally, the camera strap is provided with several arrays of equidistant distributed thread holes.

Compared with the prior art, the beneficial effects of the invention are as follows:
1. By the provision of the structures such as the external leathery friction layer and the buffer layer, the camera strap is easily connected to the camera through an external strap. The external leathery friction layer has a soft touch, and the buffer layer effectively alleviate the pressure on the back and enhance the comfort of use.

### BRIEF DESCRIPTION OF DRAWINGS

FIG. 1 shows a schematic diagram of the overall structure of the invention;

FIG. 2 shows a sectional view of the camera strap of the invention;

Wherein 1: the camera strap; 11: the external leathery friction layer; 12: internal leathery friction layer; 13: the buffer layer; 14: buffer hollow friction layer; 15: the thread hole; 2. the external strap.

### DESCRIPTION OF EMBODIMENTS

The technical solutions in the embodiments of the present application will be described clearly and completely below in combination with the accompanying drawings in the embodiments of the present application. Obviously, the described embodiments are a part of but not all of the embodiments of the present application. Based on the embodiments in the present application, all other embodiments obtained by those persons of ordinary skill in the art without paying creative work shall fall within the protection scope of this application.

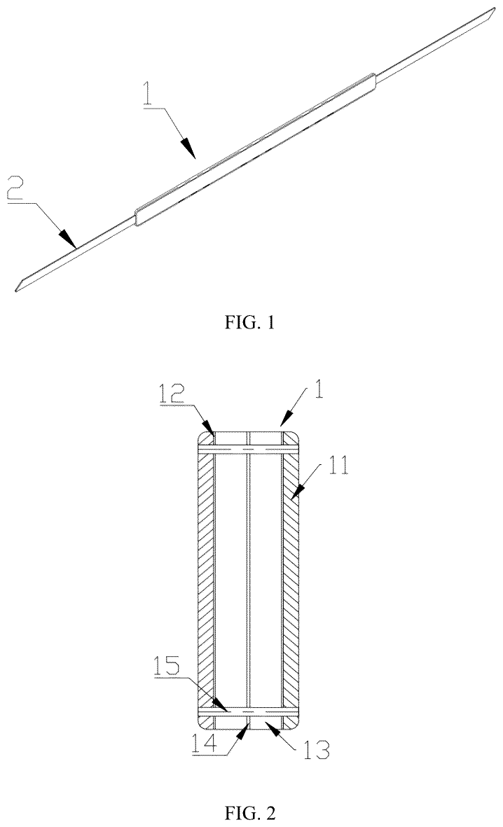

Referring to FIGS. 1-2, a novel camera strap comprising a camera strap 1 and two external straps 2, wherein the two external straps 2 are affixed to the two ends of the camera strap 1, the camera strap 1 comprises two external leathery friction layers 11 and two buffer layers 13, the two external leathery friction layers 11 are provided on the outer peripheral surfaces of the camera strap 1, the two buffer layers 13 are provided on the inner walls of the two external leathery friction layers 11, an internal leathery friction layer is provided between the external leathery friction layer 11 and the buffer layer 13. A buffer hollow friction layer 14 is provided between the two buffer layers 13, the camera strap 1 is provided with several arrays of equidistant distributed thread holes 15. By the provision of the structures such as the external leathery friction layer 11 and the buffer layer 13, the camera strap 1 is easily connected to the camera through the external strap 2; the external leathery friction layer 11 has a soft touch, and the buffer layer 13 effectively alleviate the pressure on the back and enhance the comfort of use.

The embodiments of the present application are implemented as follows: when the camera strap 1 is required for use, it is connected to the camera via the external strap 2. Once connected, the camera strap 1 is carried in a manner that positions the external leathery friction layer 11 of the camera strap in contact with the user. The leathery material of this layer provides comfort when in contact with the user. Additionally, a buffer layer is provided between the external leathery friction layer 11, which serves to buffer the camera strap 1 effectively during use, thereby enhancing the comfort experienced when using the camera strap 1.

Additionally, an internal leathery friction layer 12 is provided between the external leathery friction layer 11 and the buffer layer 13, and a buffer hollow friction layer 14 is provided between the two buffer layers 13, all of which can effectively increase the service life of the camera strap 1. By the provision of the thread holes 15, the external leathery friction layer 11, the internal leathery friction layer 12, the buffer layer 13, and the buffer hollow friction layer 14 can be connected by a thin rope, thereby enabling the production of the camera strap 1.

Although embodiments of the invention have been shown and described herein, it is apparent that various changes, modifications, substitutions, and variations can be made to the present invention by those skilled in the art without departing from the principle and spirit of the invention. The scope of the present invention is limited by the accompanying claims and their equivalents.

What is claimed is:

1. A novel camera strap, comprising a camera strap (1) and two external straps (2), wherein the two external straps (2) are affixed to the two ends of the camera strap (1), the camera strap (1) comprises two external leathery friction layers (11) and two buffer layers (13), the two external leathery friction layers (11) are provided on the outer peripheral surfaces of the camera strap (1), the two buffer layers (13) are provided on the inner walls of the two external leathery friction layers (11).

2. The novel camera strap according to claim 1, wherein an internal leathery friction layer (12) is provided between the external leathery friction layer (11) and the buffer layer (13).

3. The novel camera strap according to claim 1, wherein a buffer hollow friction layer (14) is provided between the two buffer layers (13).

4. The novel camera strap according to claim 1, wherein the camera strap (1) is provided with several arrays of equidistant distributed thread holes (15).
